(19) United States
(12) Patent Application Publication
(10) Pub. No.: US 2026/0171276 A1
(43) Pub. Date: Jun. 18, 2026

(54) RADIATION BARRIER SYSTEM AND COMPOSITION

(71) Applicant: Lithified Technologies Group, LLC, Santa Fe, NM (US)

(72) Inventors: Gilles Y. Bussod, Los Alamos, NM (US); Joshua Cantrell, Honokaa, HI (US)

(73) Assignee: Lithified Technologies Group, LLC, Santa Fe, NM (US)

(21) Appl. No.: 19/420,628

(22) Filed: Dec. 15, 2025

Related U.S. Application Data
(60) Provisional application No. 63/733,730, filed on Dec. 13, 2024.

(51) Int. Cl. G21F 3/00; G21F 1/00

(52) U.S. Cl. CPC G21F 5/015

(57) ABSTRACT

A radiation barrier system comprising: a chemically reactive base layer; a first layer at least partially disposed above the base layer; the first layer comprising a first soil; a second layer at least partially disposed above the first layer; and the second layer comprising a second soil. The chemically active base layer is a hydro-geochemical filter barrier. The chemically active base layer mitigates soluble uranium or uranyl ion transport. The chemically active base layer filters out uranyl ions. The uranyl ions are filtered out by a process of surface adsorption to a phase added to a lithified soil composition.

### CROSS-REFERENCE TO RELATED APPLICATIONS

This application claims priority to and the benefit of the filing of U.S. Provisional Patent Application No. 63/733,730 , entitled “RADIATION BARRIER SYSTEM AND COMPOSITION”, filed on Dec. 13, 2024, and the specification is incorporated herein by reference.

### BACKGROUND OF THE INVENTION

### Field of the Invention (Technical Field)

Embodiments of the present invention relate to a radiation barrier for protection against radioactive material and emissions.

### Background

Radioactive decay is the emission of energy in the form of ionizing radiation. The emitted ionizing radiation can include alpha particles, beta particles, and/or gamma rays. Radioactive decay occurs in unstable atoms or radionuclides that eventually transform into stable atomic structures. The atoms keep transforming until they reach a stable equilibrium state and are no longer radioactive. Most radionuclides only decay once before becoming stable, but others decay in several steps called the decay chain. Every radionuclide has a specific rate of decay that is measured in terms of “half-life”, or the time required for half of the radioactive atoms present to decay. Radionuclide half-lives can vary from a few seconds to hundreds, millions, or billions of years. The radioactivity of a solid or fluid (liquid or gas) can be measured in terms of their activity concentration or the amount of a radionuclide in a specific volume or mass in becquerels or picocuries per liter (Bq/L or pCi/L).

Radium Ra-226 gamma radiation can travel through solids and humans, and its daughter product Rn-222 gas is a strong ionizing alpha radiation emitter so that proximity to either or both forms of radiation can modify the human (and animal) DNA structure and fatally harm those exposed to it. The severity of this hazard and the need to “clean up” a large quantity of contaminated sites represent great technical challenges to administrators, scientists, and engineers alike. At present, a range of technical tools and methods (e.g., removal, relocation, treatment, encapsulation, and isolation) are used as a matrix of remedial actions.

The source of radioactivity from natural rock waste or processed uranium mill tailings (legacy waste) is uranium ore (U-238), which has a radioactivity that is virtually permanent or forever in terms of human existence on Earth. Because U-238 is a parent isotope with a half-life of 4.5 billion years or approximately the age of the Earth, it effectively represents a nearly infinite radioactive source if the ore formed in the last 4.4 billion years or less. In addition to the alpha, beta, and gamma particles emitted from the decay of the parent isotope, most of the daughter isotopes also emit ionizing radiation including gamma rays with energies of 0.5 MeV or less. Thorium (Th-230), radium (Ra-226), lead (Pb-210), and bismuth (Bi-214) daughter products with half-lives of 77,000 years, 1,600 years, 22.3 years, and 20 minutes, respectively, are the principal gamma emitters associated with abandoned uranium mines (“AUMs”) and uranium mill tailings. In some cases, such as the Moab uranium mill tailings in Utah, the amount of Th-230 or Bi-214 is relatively low, and Ra-226 is the principal daughter product emitter of gamma (80%). In practice, however, gamma field monitoring measurements include the total radioactivity from all radioactive isotope species present at the site surface.

Gamma radiation from processed uranium ore in uranium mill tailings or left as surface rock debris around abandoned uranium mines (“AUMs”), can represent a serious hazard to the public and surrounding environment. This health safety concern is commonly addressed by either removal of the radiation source, and/or shielding. For legacy uranium mill tailings, removal of the tailings is a preferred solution, though radiation continues to be emitted from the contaminated sub-surface at the original site, and a secondary radioactive source created by the removal and relocation of the removed radioactive material also requires shielding. For AUMs the gamma radiation is approximately 1/10^{th} of that from uranium mill tailings, and removal is cost-prohibitive, so shielding is a preferred option.

Typically, the known materials for shielding gamma-rays are reinforced concretes. However, barriers built from concrete require excess free water during installation over the contaminated area. Contact of the contaminated radioactive source with aqueous alkaline or acidic fluids can cause contaminant leaching, remobilization, and transport via surface and groundwaters. Cured concretes are also prone to cracking and subsequent water infiltration that causes leaching and remobilization of contaminant sources. In addition to being expensive, concrete is a large global contributor to greenhouse gas emissions during fabrication, transportation, and curing.

New technologies and solutions involving covers and site monitoring represent an important step in mitigating the exposure of the public and the environment to radioactive hazards. What is needed is a long-term and effective radiation barrier.

### BRIEF SUMMARY OF THE INVENTION

Embodiments of the present invention relate to a radiation barrier system comprising: a chemically reactive base layer; a first layer at least partially disposed above the base layer; the first layer comprising a first soil; a second layer at least partially disposed above the first layer; and the second layer comprising a second soil. In another embodiment, the chemically active base layer is a hydro-geochemical filter barrier. In another embodiment, the chemically active base layer mitigates soluble uranium or uranyl ion transport. In another embodiment, the chemically active base layer filters out uranyl ions. In another embodiment, the uranyl ions are filtered out by a process of surface adsorption to a phase added to a lithified soil composition.

In another embodiment, the system is disposed over uranium-contaminated mineral. In another embodiment, the first layer comprises a lithified soil. In another embodiment, the second layer comprises a lithified soil. In another embodiment, the first soil or the second soil comprises a basecourse aggregate. In another embodiment, the basecourse aggregate comprises calcium carbonate.

In another embodiment, the basecourse aggregate comprises a silicate. In another embodiment, the first soil or the second soil comprises a cementitious material. In another embodiment, the first soil or the second soil comprises an alkaline activator. In another embodiment, the first or soil the second soil comprises a clay. In another embodiment, the first soil or the second soil comprises calcium magnesium alumino-silicate. In another embodiment, the first layer or the second layer comprises metakaolin-lime.

In another embodiment, the first layer or the second layer comprises an additive. In another embodiment, the additive comprises an iron oxide. In another embodiment, the system further comprises a monitoring system. In another embodiment, the monitoring system is disposed within the radiation barrier system.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a table showing simulation results on the shielding efficiency, according to an embodiment of the present invention;

FIG. 2 is a graph showing the Ra-226 gamma shielding efficiency of the first layer, according to an embodiment of the present invention;

FIG. 3 is a table showing radiation barrier (“Rad-Barrier”) hydrologic and intrinsic physical properties, according to an embodiment of the present invention;

FIG. 4 is a graph showing the modeled response of the Rad-Barrier system to an extreme precipitation event, according to an embodiment of the present invention;

FIG. 5 is a graph showing a range of measured compressive strengths and elastic moduli (“E*”), for the base layer, and the first and second layers of the radiation barrier, according to an embodiment of the present invention;

FIGS. 6A and 6B showing radon Rn-222 gas diffusivity coefficients (“D”) and retardation factors (“R”) for Layer 1 and Layer 2 respectively, according to an embodiment of the present invention;

FIGS. 7A and 7B are graphs showing the results from steady-state Rn-222 gas diffusivity model simulations, according to an embodiment of the present invention;

FIGS. 8A and 8B are schematic diagrams of a multilayer Rad-Barrier cover design, according to an embodiment of the present invention;

FIG. 9 is a schematic diagram of a permanent, multi-layered, lithified rock-hard cover for radioactive AUM waste rock and legacy uranium mill tailings, according to an embodiment of the present invention;

FIG. 10 is a graphic showing of a multi-layered lithified rock-hard cover over radioactive tailings with arrows indicating the upward transport direction for Rn-222 gas to the cover surface and the downward infiltrating water from precipitation, according to an embodiment of the present invention.

FIG. 11 is a table showing the range of compositions for Layer 1, according to an embodiment of the present invention; and

FIG. 12 is a table showing the composition of Layer 2, according to an embodiment of the present invention.

### DETAILED DESCRIPTION OF THE INVENTION

Embodiments of the present invention relate to a radiation barrier (“Rad-Barrier”) composition and system. The radiation barrier may be multi-layered. The system may comprise a base layer, a first layer, and a second layer. The base layer may be a configured to be chemically reactive and may mitigate the aqueous transport of soluble uranium or uranyl. The first layer may be at least partially disposed above the base layer and may comprise soil and/or lithified soil aggregate. The second layer may be at least partially disposed above the first layer and may comprise soil and/or lithified soil aggregate.

The Rad-Barrier may simultaneously prevent water infiltration onto the contaminated surface, and/or mitigate uranium contaminant transport from the source area to the surrounding environment. The radiation barrier may block gamma radiation produced from the decay of radium Ra-226 and other radioactive sources. The radiation barrier may allow the gradual release of radioactive radon gas Rn-222 at a surface at activity levels less than about 20 picocuries per liter (“pCi/L”). The radiation barrier may isolate tailings and control radon emanation for at least 200 years, and up to one thousand years or more. The radiation barrier may ensure that the release of radon-222 gas from residual radioactive material (“RRM”) to the atmosphere will not exceed and be below an average of 20 picocuries per square meter per second, averaged over the entire top surface of the radiation barrier. The radiation barrier may provide effective shielding from gamma radiation.

The Rad-Barrier composition and system may be used to cover material for the remediation of abandoned uranium mine (“AUM”) contaminated waste rock, uranium-contaminated mineral, and/or uranium mill tailings. The Rad-Barrier may be erosion-resistant.

The number, thickness, and additive compositions of each layer of the Rad-Barrier system may be configured to optimize their compliance attributes for contaminated sites with different levels of radioactivity expressed as concentrations of uranium-238, thorium-230, radium-226, bismuth-214, lead-210, and radon-222 gas. The Rad-Barrier may comprise strong, high-density material to enhance gamma-ray shielding properties and satisfy barrier strength and durability requirements.

The Rad-Barrier system may comprise a multi-layered cover design that may simultaneously eliminate the radiation hazard to the public, livestock, and wildlife by isolating contaminated waste rock piles (e.g., Abandoned Uranium Mines) or uranium mill tailings from the surrounding environment.

The Rad-Barrier system may comprise a base layer. The base layer may be a uranium ion capture layer. The base layer may mitigate the aqueous transport of soluble uranium or uranyl [UO₂]²⁺ by filtering out uranyl ions by a process of surface adsorption to a phase added to a lithified soil composition. This may prevent further soluble uranium transport and contamination of the groundwater by filtering uranyl out of water produced by condensation at the base of the cover and within the contaminated source, and/or by impeding migration of contaminated surface water from the source to the accessible environment. The base layer may be configured to immobilize and/or retard the transport of soluble uranium (uranyl) in surface waters contaminated by radioactive uranium in waste rock and uranium mill tailings.

The base layer may be configured to exhibit mechanical integrity such that it is strong enough to provide structural support to the hardened first and second layers overlying it, and/or support vehicle loads and/or heavy machinery. The base layer may be configured to be resistant to shrinking and/or swelling to mitigate cracking of top layers. The base layer may be configured to exhibit high hydraulic conductivity such that its porosity and/or permeability will allow surface water from condensation in the waste piles or tailings to flow through or drain gravitationally. The base layer may be configured to be chemically reactive such that it is able to act as a hydro-geochemical filter barrier that may mitigate soluble uranium or uranyl ion transport. Uranyl transport may occur during condensation or in the presence of ephemeral surface rainwater that may migrate at the interface of the Rad-Barrier system and the ground surface. This form of soluble uranium is extremely hazardous if transported into the surrounding environment and drinking water supply.

The Rad-Barrier may comprise a first layer. The first layer may be disposed above the base layer, and may shield the surrounding environment from up to 100% of the ionizing gamma radiation emitted by the radioactive decay of U-238, Th-230, Bi-214, Pb-210, and/or Ra-226 decay products. The first layer may comprise a lithified soil aggregate and/or soil. The first layer may further comprise an additive. The first layer may comprise a thickness of at least about 1 inch, about 1 inch to about 36 inches, about 2 inches to about 32 inches, about 4 inches to about 28 inches, about 8 inches to about 24 inches, about 12 inches to about 20 inches, or about 36 inches.

The Rad-Barrier may comprise a second layer. The second layer may be disposed above the first layer and may be a top cover layer. The second layer may comprise a lithified soil aggregate and/or soil. The second layer may further comprise an additive. The second layer may be configured to produce a rock-hard, erosion-resistant permanent cover built to last at least about 1,000 years and that may withstand strong winds and severe erosion from future extreme precipitation events (e.g., climate change conditions, flash floods, and tornadoes). The second layer may be configured to mitigate the formation of airborne radioactive dust particles and/or curtail animal burrowing activity or tap-root damage. The second layer may be configured to be freeze-thaw resistant. The second layer may comprise a thickness of at least about 1 inch, about 1 inch to about 36 inches, about 2 inches to about 32 inches, about 4 inches to about 28 inches, about 8 inches to about 24 inches, about 12 inches to about 20 inches, or about 36 inches.

The Rad-Barrier system may comprise a combined first and second layer. The combined layers may be configured to block and/or impede Rn-222 alpha ionizing gas radiation. The combined first and second layer may be configured so that coupled radioactive decay, travel time, and gas sorption by additive phases in the lithified soils, may result in the reduction the overall radioactivity of the radon gas reaching the cover surface to concentrations that are below 20 pCi/L at the surface.

The Rad-Barrier system may be comprised of a monitoring system at its surface, at its base and/or within the barrier itself at different depths. Gamma activity, radon gas emanation concentrations, humidity or layer saturation, and barrier damage may be monitored using appropriate probes and detectors used to verify compliance with health and regulatory recommendations and standards.

The terms “radiation barrier”, “Rad-Barrier”, and “Rad-Barrier system” are used interchangeably herein.

The terms “SF-Gray” and “SFG” are used interchangeably herein to mean Santa Fe Gray soil.

The terms “Layer 1” and “first layer” are used interchangeably herein.

The terms “Layer 2” and “second layer” are used interchangeably herein.

The term “soil” as used herein includes, but is not limited to, stone fragments, gravel, and sand; silty or clayey gravel sand; fine sand; silty soils; clayey soils; or a combination thereof. Santa Fe Gray (“SFG”) soil is a basecourse aggregate comprising stone fragments, gravel, and sand. The SFG soil and/or base aggregate material may comprise clay, feldspar, quartz, or a combination thereof. The base aggregate may comprise calcium carbonates (e.g., calcite, dolomite, caliche), a silicate (e.g., quartz, feldspar), and/or a combination thereof. The base aggregate material may be at least about 35%, about 35% to about 40%, about 40% to about 45%, about 45% to about 50%, or about 50% calcium carbonate by weight. The base aggregate material may also comprise up to about 36% quartz by weight. The base aggregate material may comprise at least about 12%, about 12% to about 16%, about 16% to about 20%, or about 20% feldspar (e.g., plagioclase, orthoclase, albite) by weight.

The term “SFG*” as used herein means SFG soil with added formula A, and/or formula B, and/or formula C, and/or formula D wherein the formulas comprise a mixture of cementitious materials and alkaline activators (A), clay (B), calcium magnesium alumino-silicate mineral powder (C), and metakaolin-lime powder (D). SFG* may also refer to a method whereby unconsolidated soils and aggregates are turned into stone via cementation by compaction, chemical reaction, and recrystallization, and/or a combination thereof.

The term “Additive X” or “NC” as used herein means a mineral mixture

comprising an iron oxide. A high-density component added to Layer 1 may optimize radiation protection properties and hydrologic characteristics.

The term “clay” as used herein includes, but is not limited to, mudrock, clay material, or clay minerals such as bentonite, smectite, kaolinite, and/or illite. As a soil constituent and additive, the clay may comprise at least about 2-15%, and up to about 60%, about 60% to about 65%, about 65% to about 70%, about 70% to about 75%, about 75%, to about 80%, or about 80% clay by weight. The clay may comprise at least about 15%, about 15% to about 20%, about 20% to about 25%, or about 25% feldspar by weight. The clay may also comprise up to about 19% feldspar by weight. The clay may comprise at least about 5%, about 5% to about 10%, about 10% to about 15%, or about 15% quartz by weight. The clay may also comprise at least about 9% quartz by weight. The clay may also comprise calcite, anhydrite, or a combination thereof. The clay may comprise at least about 3%, about 3% to about 8%, about 8% to about 12%, or about 12% structurally bound water by weight.

In one embodiment “chemically reactive” able to achieve a chemical reaction with a metal or metal ion.

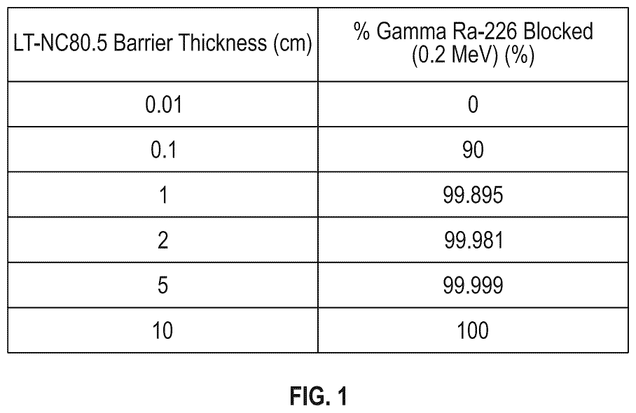

Turning now to the figures, FIG. 1 shows 3-D simulation results on the Ra-226 gamma shielding efficiency of Rad-Barrier Layer 1 (“SFG-NC 80.5”) subjected to 0.2 MeV Ra-226 Gamma-ray (“γ”) emission energy. The results show that a one-foot (30.5 cm) thick Rad-Barrier Layer 1 may block 99.98% to 100% of the radium-226 gamma radiation within the first two centimeters to five centimeters (0.8 inches to 2.0 inches) of a radioactive gamma source with an energy level of 0.2 MeV, equivalent to the radiation activity concentration of a typical uranium mill tailings site of 700 pCi/g.

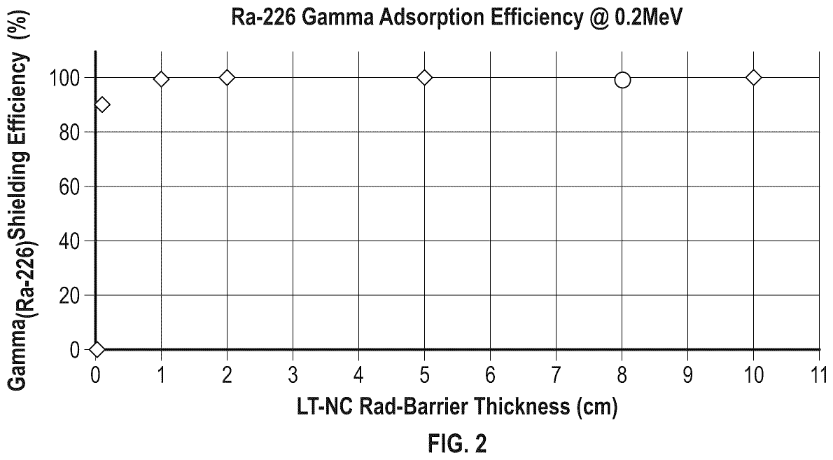

FIG. 2 shows the steady state penetration distance of Ra-226 gamma radiation into the Rad-Barrier Layer 1 for 0.2 Mega electron volts (“MeV”) Ra-226 gamma energy, based on 3-D model simulations. About 99.9% to about 100% shielding from the gamma radiation occurs at the base of Layer 1 within a two-centimeter, and 2 cm to 5 cm penetration distance from the radiation source, respectively. Also plotted for comparison is the result of a simple 1-D analytical calculation for blocking 98% of a 0.2 MeV source energy (yellow circle). 3-D model simulations include primary and secondary gamma interaction effects within Layer 1 and indicate that the gamma shielding by the Rad-Barrier Layer 1 is over eight times more effective at blocking gamma radiation than predicted by the simple 1-D analytical calculation.

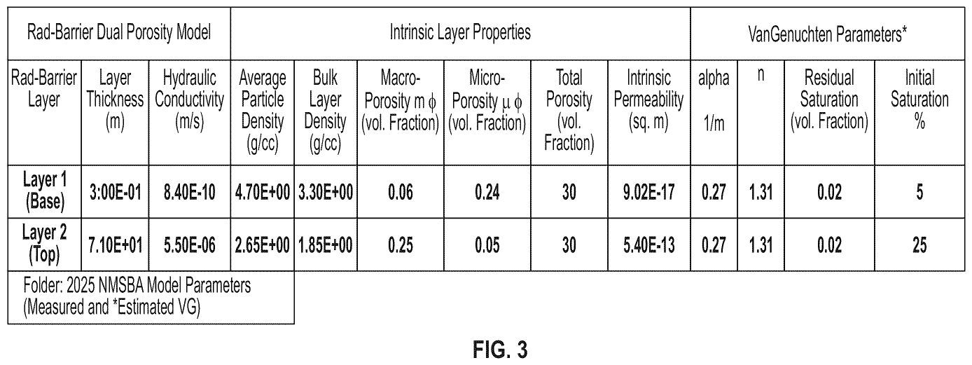

FIG. 3 shows a table summary of the measured Rad-Barrier hydrologic properties and intrinsic property parameters for Layer 1 (LT NC80.5-3) and Layer 2 (LT SFG*) used as inputs to in a 1-D finite element heat and mass (“FEHM”) flow and transport model used in FIG. 4.

FIG. 4 shows the effect of a severe two-hour rainfall event on the Rad-Barrier cover subjected to a three inches per hour downpour. The results from a 2-D multiphase flow and transport model are represented as columnar one-meter-thick vertical sections through Layer 1 and Layer 2, representing water infiltration into the cover, up to 48 hours after the initiation of precipitation and water accumulation at the cover surface. Cover depths from 0 meters to 1 meter (3.3 ft) are shown at the left of each column. Details of the evolution of the saturation front in a 1-meter cover column are shown before the event (t₀=0 hours), during the event (t=1 hour and 2 hours), and for up to two days after the initiation of the rainfall (t=6 hours, 24 hours, and 48 hours). Saturation volume fractions are shown at the right of each column, representing the lowest water saturation state (0% to 5%), and the highest saturation (95% to 100%). The initial saturation states at time t₀ for Layer 1 and Layer 2 are respectively 5% (dark blue) and 25% (lighter blue). Optionally, Layer 1 and Layer 2 may be about 30 cm and about 70 cm in thickness, respectively.

The two-hour extreme precipitation event corresponds to a precipitation (rainfall) rate of 3 in. /h. The multi-layered Rad-Barrier system is about 1 meter thick (about 3.3 ft), and the depth from the cover surface (0 m) is shown at the left of each column. Layer 1 at the base of the cover is 0.3 meters (11.8 inches) thick, and Layer 2 above it is 0.7 meters (27.6 inches) thick. Initially, at time t₀ (=0 h), Layer 1 and Layer 2 are respectively 5% water-saturated and 25% water-saturated. During and after the 2-hour surface precipitation event, the evolution of the infiltrating water from the cover surface (top of Layer 2) results in a water saturation front within the second layer. Saturation volume fractions are shown at the right of each column as a bar where the top region of the bar represents the highest saturation state (95-100%), and the bottom region of the bar represents the lowest saturation state (0%-5%). One hour (1 h) and 2 hours (2 h) after the initiation of the precipitation event (assuming a pool of water forms immediately at the barrier surface), the saturation front in Layer 2 has reached depths of approximately 0.3 meters and 0.4 meters, respectively. In both cases, the top of Layer 2 is fully saturated. Six hours (t=6 h) after the initiation of precipitation or four hours after the end of the event, the saturation front has reached a depth of 0.5 meters, however, the saturation at the top of Layer 2 has dropped to 70% and the surface has dried out. After one to two days (24-48 h) the saturation front has reached the Layer 1-Layer 2 interface but the saturation is only 45%.

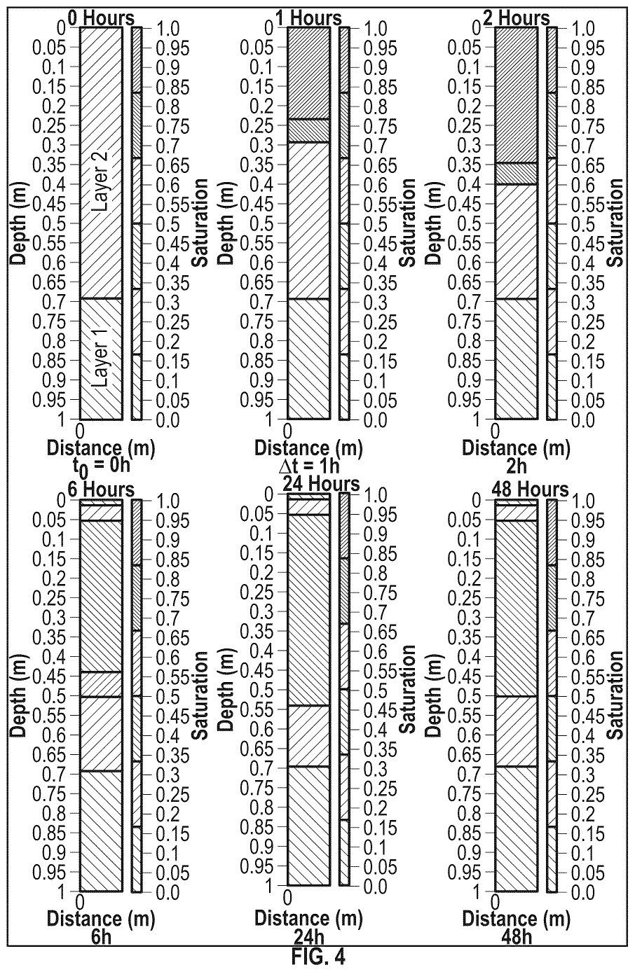

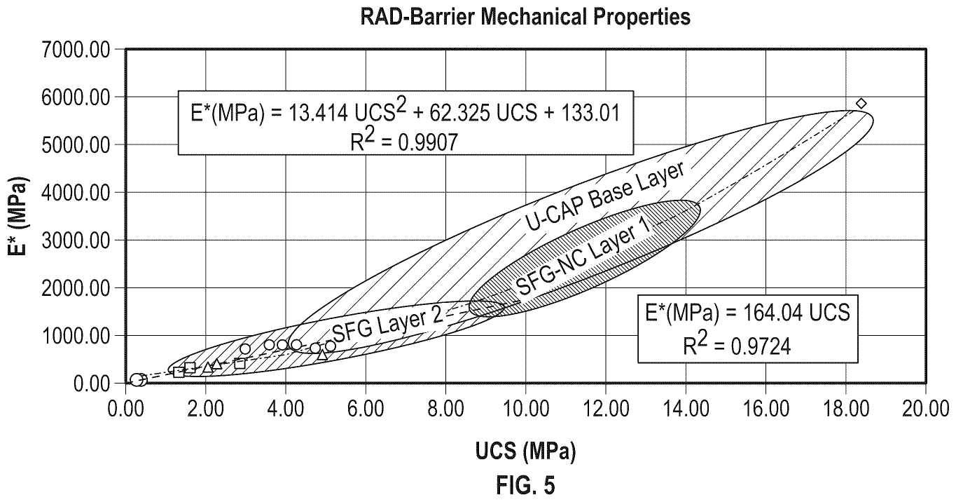

FIG. 5 shows the range of measured unconfined compressive strengths (“UCS”) and elastic moduli (“E*”) that may be configured for Rad-Barrier Base Layer, Layer 1, and Layer 2. From left to right, the fields represent Layer 2, the Base Layer, and Layer 1 mechanical property ranges. The open circles represent untreated SFG soils, and in SFG Layer 2 the circles, triangles, and squares represent treated, lithified SFG* aggregate soil mixtures with respectively 4%, 8%, and 12% amendment ‘B’ added. In the Base Layer, the open and solid diamond symbols show the low and high range of different base layer cover compositions made using additives to the lithified SFG soil. The Layer 1 field overlaps with the fields for the Base Layer and Layer 2. The empirical equations for the Elastic Modulus (E*, in MPa) in terms of the unconfined compressive strength (UCS, in MPa) in the boxes refer respectively to the overall fit to the total data set (dashed curve for whole data se), and a linear fit to the Layer 2 data only (dashed line for Layer 2 data).

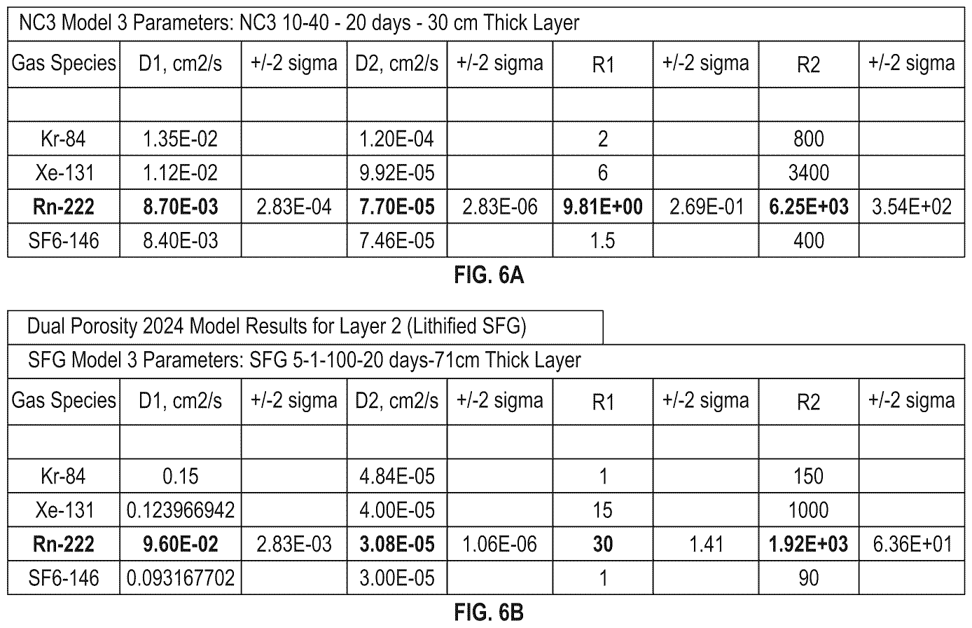

FIGS. 6A and 6B show tables of calculated diffusivity coefficients (“D”) and retardation factors (“R”) for radon (Rn-222) gas in Layer 1 (NC3) and Layer 2 (SFG*), respectively. The Rn-222 noble gas values were determined using the van der Waals non-ideal gas law, and a 2-D dual porosity diffusion model, using gas diffusion laboratory test results for the noble gases krypton (Kr-84) and xenon (Xe-131), and a heavier molecular sulfur hexafluoride (SF6-146) gas.

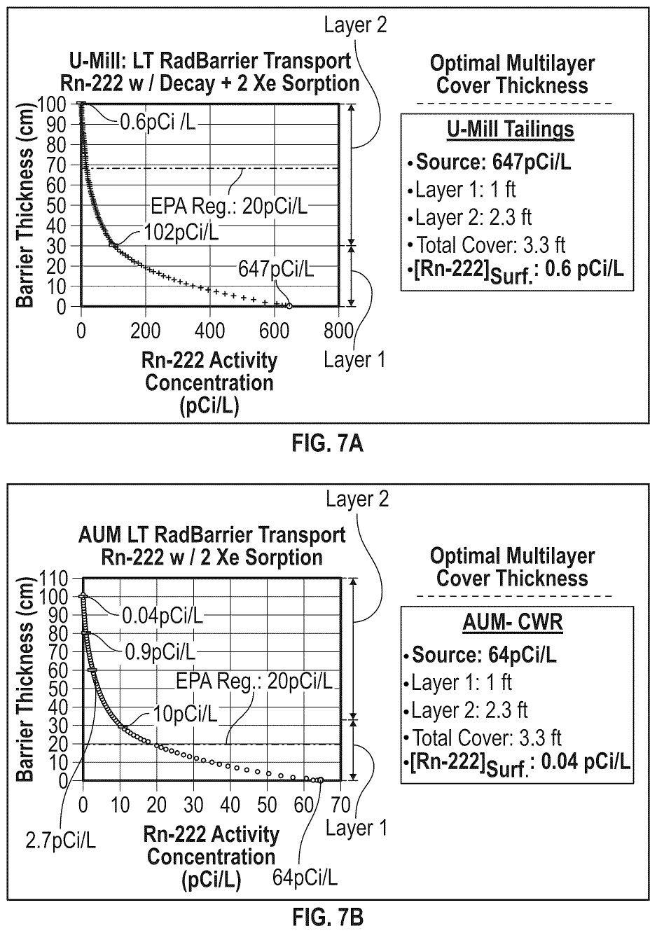

FIGS. 7A and 7B represent the steady-state Rn-222 gas diffusivity model forecasts at secular equilibrium for gas radioactivity concentrations as a function of Rad-Barrier depth from the base (0 cm) of Layer 1 to the top surface of Layer 2 (100 cm). The steady-state Rn-222 gas diffusivity model predicts the radioactivity concentrations at the surface of the Rad-Barrier cover for a uranium mill tailings site (FIG. 7A), and a contaminated waste rock (CWR) from an abandoned uranium mine (FIG. 7B). The U-mill tailings source radioactivity concentration (647 pCi/g) is an order of magnitude larger than the AUM CWR concentration (64 pCi/g). The Rad-Barrier cover is designed to protect the public and surrounding environment from radioactivity in U-mill tailings and AUM contaminated waste rock (“CWR”) so that regulatory safe radon gas concentrations in air of less than 20 pCi/L are achieved in both cases, 30 cm below the cover surface in Layer 2 for U-mill tailings, and 80 cm below the cover surface in Layer 1 for AUMs. Using the Ra-222 gas diffusion data, the model results show that the radon Rn-222 gas concentrations at the cover surface in both cases are 300 times (0.6 pCi/l), and 500 times (0.04 pCi/l) lower than the 20 pCi/L EPA regulatory limit for U-mill tailings, and AUM sites, respectively, which is tolerable and/or safe for humans.

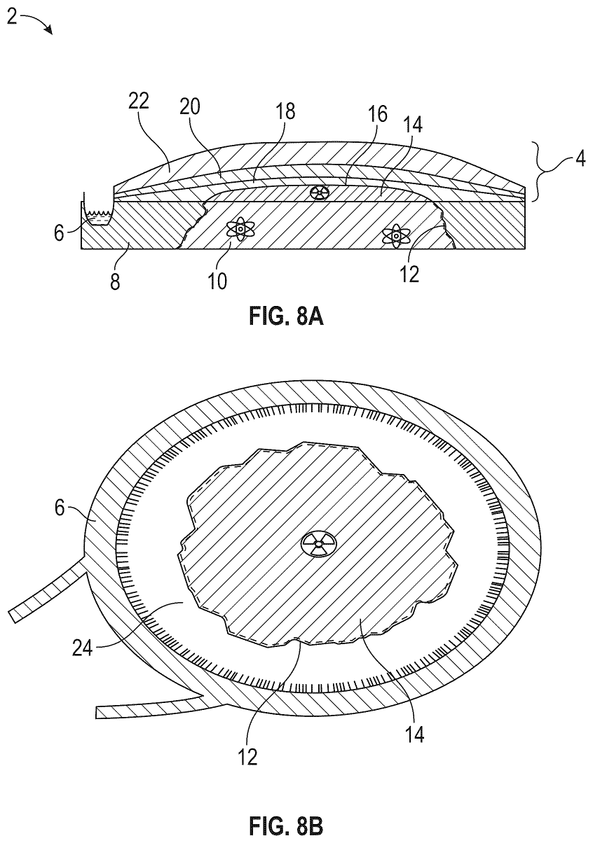

FIGS. 8A and 8B showing a cross-section and top-down perspective, respectively, of the Rad-Barrier system 2, comprising the multi-layered Rad-Barrier 4, disposed over contaminated material (e.g., uranium tailings) 14. Rad-Barrier 4 comprises a base layer 18, a first layer 20, and a second layer 22. The base layer 18 is disposed above the contaminated uranium tailings 14, along a boundary 16, with the tailings 14. Optionally, base layer 18 is one foot in thickness. First layer 20, is disposed above the base layer 18, and below the second layer 22. Optionally, first layer 20 is approximately one foot thick in thickness. Rad-Barrier 4 is surrounded by a culvert system 6, for collecting and diverting precipitation water away from the barrier cover 4. The barrier cover 4 includes the second layer 22 that extends beyond the footprint of contaminated material 14 (FIG. 8B). Subsurface radioactive material 10 extends from contaminated surface material 14, and into the uncontaminated ground 8 where it disperses with depth 12. Subsurface radioactive material 10 spreads laterally beyond the circumference of contaminated material 14 as indicated by radioactive material subsurface boundary 12.

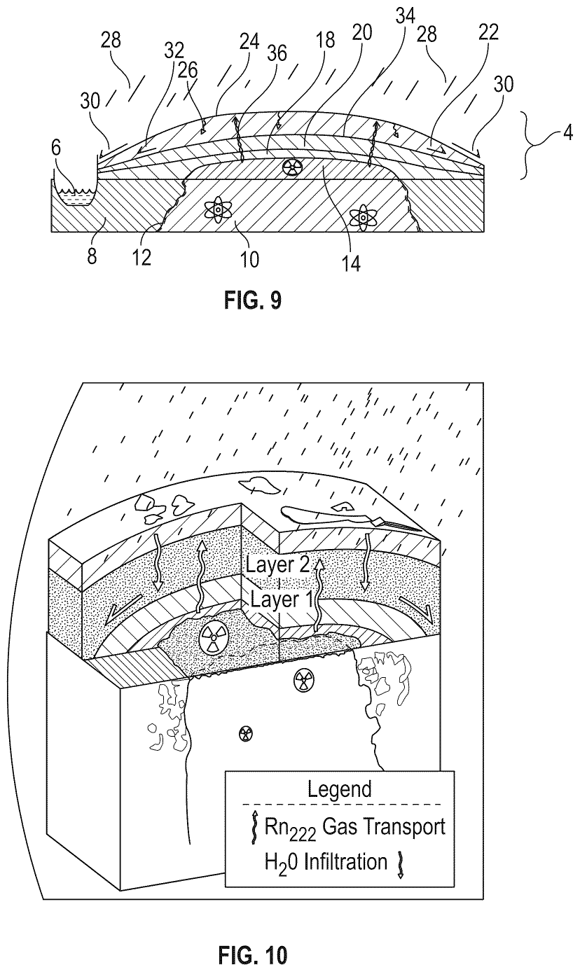

FIG. 9 shows a schematic cross-section of Rad-Barrier 4 comprising of several layers over contaminated surface material 14. Rad-Barrier 4 is configured to be permanent, multi-layered, and comprises a lithified rock-hard cover for radioactive AUM waste rock and legacy uranium mill tailings. The barrier material is distinguishable from organically bonded materials in that it involves cementation via mineral reactions (recrystallization, and mineral rim growth by solution-precipitation); compaction; and/or accelerated curing times that produce rock-like properties. Rad-Barrier 4 comprises base layer 18, first layer 20, and second layer 22 and is disposed over contaminated surface material 14. Due to years of surface infiltration and contamination, the subsurface of AUMs and uranium mill tailings is contaminated by radioactive material 10 that has infiltrated into the subsurface immediately below the contaminated material 14. This subsurface radioactive material is dispersed along subsurface boundary 12 into uncontaminated ground 8. Rainwater 28 from a precipitation front may cause water to accumulate along the top surface of the barrier cover 4 and drain along sides 30 into culvert system 6. Infiltrating rainwater 26 flows through the second layer 22 and is dispersed laterally within it. At the Layer 1-Layer 2 interface 34 the downward water flow is impeded as it acts as a capillary barrier (‘Richards barrier’) to water penetration that causes any infiltrated surface water to divert and drain laterally to the sides within the second layer 22 along path 32 and into culvert system 6. Radioactive radon gas (e.g., Rn-222) 36 emanating from contaminated material 14 rises through all layers of Rad-Barrier system 4. The layers of Rad-Barrier 4 delay the transport of radon gas 36 to the surface and over time attenuate its radioactivity by radioactive decay. In this way, the activity of radon gas 36 at the surface of Rad-Barrier 4 is lowered to a non-hazardous level (about 0.01 pCi/L to about 1.0 pCi/L), which is well below the concentration limit of 20 pCi/L safe for human exposure.

FIG. 10 shows a graphic of the permanent multi-layered lithified rock-hard cover (the Rad-Barrier) for AUM contaminated waste rock (“CWR”), and uranium-mill tailings. The Rad-Barrier is configured to last at least about 200 years, about 200 years to about 1000 years, about 300 years to about 900 years, about 400 years to about 800 years, about 500 years to about 700 years, or over about 1000 years. The Rad-Barrier isolates the radioactive CWR or mill-tailings from erosion and water infiltration via Rad-Barrier Layer 1 and Layer 2. Layer 1 shields the environment from ionizing gamma radiation. Layer 1 and Layer 2 protect the environment from hazardous concentrations of alpha Rn-222 gas radiation. The base layer provides a smooth surface for the Rad-Barrier system construction and may mitigate leaching of uranium ore and formation of soluble uranium (e.g., uranyl) from a humid radiation waste pile, preventing contaminant transport to the environment and/or the groundwater. Layer 1 and Layer 2 are rock-hard, erosion-resistant, and multi-layered to withstand severe erosion from future extreme precipitation events (e.g., flash floods, tornadoes). The cover also mitigates the formation of airborne radioactive dust particles, curtails animal burrowing activity and tap-root damage, and is freeze-thaw resistant.

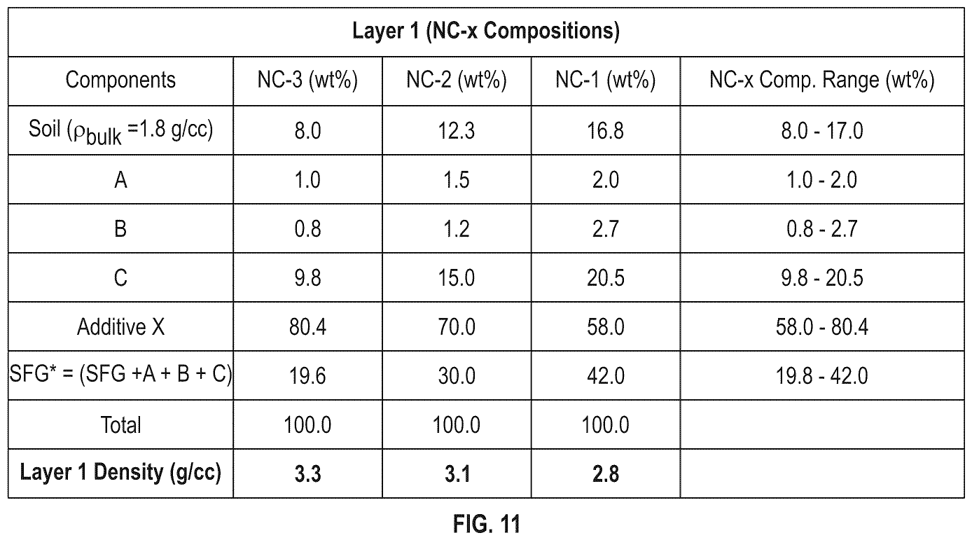

FIG. 11 shows a range of compositions and densities for Layer 1 adaptable to different radioactive sources. Layer 1 comprises the lithified soil SFG* that includes Soil, formula A, formula B, formula C, and Additive X.

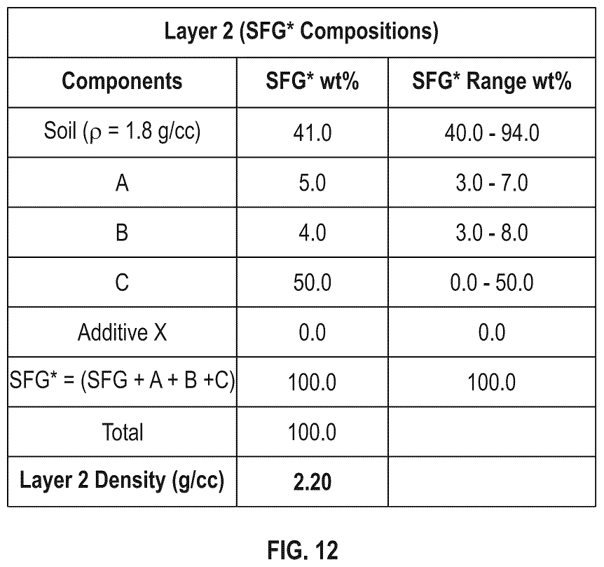

FIG. 12 shows a range in compositions for Layer 2 based on different soils. Layer 2 comprises Soil, formula A, formula B, and formula C.

The formula mixture may comprise formula A, formula B, and/or formula C. This mixture may be combined with water and unconsolidated soils and rock aggregates, where it reacts with, and “cements” the constituent minerals and aggregate rock fragments together via processes of compaction, chemical reaction, and dissolution and/or recrystallization.

In the presence of water, the formula mixture “may comprise at least about 80%, about 80% to about 85%, about 85% to about 90%, about 90% to about 95%, or about 95% calcium-aluminosilicate material by weight. Formulas A, B, and C may comprise different proportions of calcium alumino-silicate (“CAS”) minerals, clay minerals, and calcium magnesium alumino-silicates (“CMAS”) minerals respectively. The formula mixture may comprise at least about 2%, about 2% to about 3%, about 3% to about 4%, about 4% to about 5%, about 5% to about 6%, or about 6% magnesium oxide (“MgO”) by weight. The formula mixture may comprise CAS and CMAS minerals, calcium sulfate anhydrite (“CaSO₄”), and/or gypsum with structurally bound water (“CaSO₄·2H₂O”), or a combination thereof.

Layer 1 composition may vary based on the energetic intensity of the radiation to be contained by the Rad-Barrier cover. For Moab-type uranium mill tailing sites, the thickness of Layer 1 may be about 30 cm (≈12 in.). Composition NC-3 may be configured to block gamma radiation and contain dangerous concentrations of radon gas from uranium mill tailing sites. The composition may comprise 8 wt % to 17 wt % locally sourced soil with a formula mixture and water, and about 1 wt % to 3 wt % formula A, 1 wt % to 3 wt % formula B, and 10 wt % to 21 wt % formula C (FIG. 11). This results in a lithified soil composition SFG* to which amendment X is added. Layer 1 optimized for a Moab-type uranium mill tailings site is about 80 wt % amendment X, and about 20 wt % lithified soil SFG*. This composition results in a high bulk density (2.8 g/cc-3.6 g/cc), dual porosity, and a low hydraulic conductivity layer. For abandoned uranium mine (“AUM”) sites where the radioactivity of the waste rock is typically an order of magnitude less than for uranium mill tailings, Layer 1 composition may be modified to compositions NC-1, NC-2 or NC-3.

Layer 1 may comprise a bulk density of about 2.8 g/cc to 3.1 g/cc, about 3.2 g/cc to 3.4 g/cc, and about 3.5 g/cc to 3.6 g/cc, which corresponds to a compositional range for additive X of about 30 wt % to about 90 wt %, about 30 to about 50 wt %, 55 wt % to about 85 wt %, about 60 wt % to about 80 wt %, about 65 wt % to about 75 wt %, or about 90 wt %. Layer 1 may also comprise about 15 wt % to about 45 wt %, about 20 wt % about 40 wt %, about 25 wt % to about 35 wt %, or about 45 wt % SFG*.

The Layer 2 composition SFG* may be configured to restrict the activity or lethal concentration levels of radioactive radon gas (Rn-222) from reaching the cover surface. For Moab-type uranium mill tailing sites, the thickness of the SFG* layer may be about 70 cm (27 in.). The SFG* Layer 2 may comprise about 41 wt % locally sourced soil with a formula mixture of water mixed with approximately 5 wt % formula A, 4 wt % formula B, and 50 wt % formula C. Compared to Layer 1, the Layer 2 composition may be configured for uranium mill tailings results in a lower density (1.8 to 2.3 g/cc), porous layer with a higher hydraulic conductivity. Because local soils vary in composition, Layer 2 may be customized for a range of soil chemistries (basic and acidic). The range in the compositional components for Layer 2 varies from about 40 wt % to about 95 wt % of local soil and aggregate mixtures, about 3 wt % to about 7 wt % formula A, about 3 wt % to about 8 wt % formula B, about 0 wt % to about 50 wt % formula C. For abandoned uranium mine (AUM) sites where the radioactivity of the waste rock may be an order of magnitude less than for uranium mill tailings, Layer 2 thickness may be decreased, and the composition may be configured to accommodate a range of soil types and chemistries.

### INDUSTRIAL APPLICABILITY

The invention is further illustrated by the following non-limiting examples.

Components of the Rad-Barrier system were evaluated in terms of their physical and chemical properties, including mechanical strength, porosity structure, composition, mineralogy, hydraulic conductivity, Ra-226 gamma-ray shielding efficiency, and Rn-222 gas diffusivity. Test and model results indicated that the rock-hard, porous Rad-Barrier cover was superior in performance to cement covers and unconsolidated covers made from soil, sand, clay, and gravel; over 60% thinner than other systems; and was permanent, e.g., operable for over 1,000 years.

### EXAMPLE 1

Prior to the experimental determination of the uranium sorption capacity of the lithified base layer, intrinsic physical, mineralogical, and chemical properties of the aggregate soil were modified and optimized to simultaneously satisfy the structural integrity and hydrologic property requirements. This involved mechanical testing (unconfined compressive test (“UCS”), Brazil tensile strength (“BTS”), characterization of bulk composition (X-ray fluorescence or “XRF”), and mineralogy (quantitative X-ray diffraction or “qXRD”), micro-structure (optical and scanning electron microscopy), and hydraulic conductivity and intrinsic permeability measurements.

### EXAMPLE 2

The radioactivity of tailings was evaluated. The highest gamma exposure assumed was based on the Moab site, UT, where the mine tailings contain uranium ore with 99.28 wt % U-238, 0.711 wt % U-235, and 0.0039 wt % U-234 and minor Th-282. The tailings had no more yellow cake (U₃O₈) and the uranium decay products were principally U-238, U-234, Th-230, Ra-226, (Rn-222), Bi-214 and Pb-210. Together these uranium daughter products represented over 85% of the radiation. The calculated average Ra-226 activity from the tailings, assuming secular equilibrium, was approximately 647 pCi_{(U-238)}/g_{(U-Ore)}. This corresponded to an estimated gamma source energy of 0.2 MeV or an exposure rate of over 1,340 microrads per house (“μrad/h”) or 12 rad per year (“rad/y”).

### EXAMPLE 3

To determine the shielding efficiency of the Rad-Barrier Layer 1 composition LT-SFG-NC 80.5, a series of 3-D model simulations were conducted using a general-purpose 3-D n-particle transport code that applies to neutrons, photons, electrons, ions, and many other elementary particles with energies of up to one tera electron volts per nucleon (“TeV/nucleon”). The compositions of each major mineral phase present in the first layer were used to calculate the gamma ray shielding efficiency of the material. The 3-D simulations are run iteratively until a shielding distance is obtained. A shielding efficiency of 99.99% was achieved within 5 cm (approx. 2 inch) into the 30 cm (11.8 inch) thick Layer 1 cover for a 0.2 mega electron volt (“MeV”) energy source. This was equivalent to an average Ra-226 gamma activity of 640 pCi/L to 670 pCi/L calculated for Moab site uranium mill tailings.

### EXAMPLE 4

To derive the transport properties of radon Rn-222 gas for the first and second layers of the Rad-Barrier and the multi-layered Rad-Barrier system in its entirety, a mass transfer code was used to analyze the gas diffusion test results for Kr-84, Xe-131, and SF6-146. The radon gas diffusion coefficients for the first layer of the Rad-Barrier (NC-3) and the second layer of the Rad-Barrier (SFG*) were derived using a two-dimensional (2-D) dual porosity model and the measured a and b coefficients of the van Der Waals equation of state for a non-ideal (i.e., real) gases, shown by Equation (1) below.

$$( P + a . {n}^{2} / {V}^{2} ) \times ( V - n . b ) = n . R 7 \qquad ( 1 )$$

Based on digital microscopy analyses, physical property measurements, and diffusivity test results for first and second layers, dual porosity models were used to fit the gas data for both the NC3 and SFG samples respectively, each containing (i) a macro-porosity component with a diffusivity (D1) and retardation factor (“R1”), and characterized by relatively large discrete pore sizes greater than 25 μm, and (ii) a micro-porosity component with a diffusivity (D2) and retardation factor (R2), and characterized by micron-to sub-micron pore sizes.

### EXAMPLE5

The diffusivities of Rn-222 gas in the LT Rad-Barrier components Layer 1 and Layer 2 were determined using spiked concentrations of 2 noble gases of increasing atomic mass Krypton-84 and Xenon-131, and a heavier molecular gas, sulfur-hexafluoride (SF6-146) to realistically model radioactive gas plumes emitted by uranium mill tailings and AUM waste rock piles that could diffuse through the barrier system. For the gas diffusivity measurements, compressed, lithified cylinders of Rad-Barrier soil mixtures for Layer 1 and Layer 2 were tested in a gas diffusion cell coupled to a mass spectrometer to measure the breakthrough concentrations of each tracer gas over time.

### EXAMPLE 6

The transport capacity (e.g., permeability and hydraulic conductivity) of the Rad-Barrier was measured and used in a one-dimensional (“1-D”) finite element heat and mass (“FEHM”) flow and transport model to test the response of the barrier system to future “extreme” weather event scenarios. The FEHM transfer code simulates groundwater and contaminant flow and transport in subsurface fractured and non-fractured porous media.

FIG. 4 shows the response of the Rad-Barrier to an “extreme precipitation event” that is consistent with future climate change scenarios and drought conditions that involve a drastic increase in the frequency and magnitude of severe storms. The finite element, heat, and mass (FEHM) code was used to forecast the effects of a two-hour precipitation event of three inches of rainfall per hour, with ponding at the top of the cover. Water infiltration from the six-inch pool of water through the one-meter-thick (3 ft) barrier surface and the migration of a saturation front were tracked for up to two days, and longer (one year).

Within the first hour of the precipitation event and pooling on the cover surface (FIG. 4, Δt=1 h), the top 20 cm to 25 cm of the 70 cm thick top barrier cover Layer 2 was 80-100% saturated.

After 2 hours, at the end of the precipitation event (FIG. 4, Δt=2 h), Layer 2 was

65-100% saturated to a depth of 35 cm.

At 6 hours or four hours after the 2-hour event (FIG. 4, Δt=6 h), the saturation front was at a depth of approximately 55 cm in Layer 2, but the top few centimeters were drying out, and the saturation was homogenized to 70%-80% within Layer 2 from 5 cm to 50 cm depth. Below 55 cm, Layer 2 retained its initial saturation state of 25%, and Layer 1 remained unaffected by the surface event. After 2 days the saturation (FIG. 4, Δt=48 h) Layer 2 was nearly homogenized to 45-50% saturation and it remained 32% saturated one centimeter above the interface with Layer 1.

After 3-4 days the saturation front affected the top 1 cm of Layer 1 only as the saturation of Layer 2 at the interface dropped to 40% (Figure not shown) as the saturation front dissipated within Layer2.

After 5 days (3 days after the precipitation event) the saturation at the top 1 cm of Layer 1 approached 10% as the saturation in Layer 2 reached 40% 1 cm above the interface.

After approximately 15 days the saturation in Layer 2, a centimeter from the Layer 1-Layer 2 interface, peaked at 42% and decreased thereafter as the saturation signature of the precipitation event dissipated.

After 30 days the Layer 2 saturation homogenized and dropped as the water drained laterally and began to leave the Layer 2 domain.

After 40 days, the saturation in Layer 1 increased to 27% within the top centimeter but the saturation below that horizon, 5 cm from the Layer 1-Layer 2 interface remained unchanged from its initial value of 5% even after a year.

After 300 days, the saturation in Layer 2 dropped below 25%. In Layer 1, capillary pressure pulled the water downward from Layer 2. However, the high capillary retention in Layer 1 also kept the water within the first centimeter of the interface, which then acted as a barrier to further infiltration from above, effectively stopping water infiltration reaching the tailings.

### EXAMPLE 7

The uranium sorption capacity of the base layer was evaluated. Prior to the experimental determination of the uranium sorption capacity of the base layer, intrinsic physical, mineralogical, and chemical properties of the aggregate soil were modified and optimized to simultaneously satisfy the structural integrity and hydrologic property requirements. This involved mechanical testing (UCS, BTS), bulk composition (XRF) and mineralogic (qXRD) determinations, microstructural characterization (optical and scanning electron microscopy), hydraulic conductivity and intrinsic permeability measurements.

The compositionally and mineralogically modified soil was tested in the laboratory to assess the optimum formulation for the uranium sorption capacity in a uranium capping system design using a series of uranium batch sorption experiments to obtain the equilibrium constant for the partitioning of uranyl ion (“U^{VI}”) between the aqueous solution and the solid phases.

The pH range of the aqueous synthetic surface water (“SSW”) solution used in the uranium batch sorption experiments was varied between 7.0 and 8.4 to match the compositional range of natural southwest United States regional surface waters, and was measured before and after each test to evaluate the reactivity and buffering capacity of the lithified soil mixtures to the SSW solutions. Equilibrium batch uranium sorption experiments conducted on unconsolidated aggregate soil, and lithified soil mixtures using different modifiers were all buffered to an aqueous alkaline fluid (pH=8.2).

Based on the test results, the optimized base layer composition resulted in mechanically strong (UCS=8 MPa-18 MPa), permeable (>400 mD) media with a uranium sorption capacity (Kd(U^{IV})≥10 L/kg) that exceeded the value measured for other unsaturated zone uranium retardation barriers by more than a factor of three.

The preceding examples may be repeated with similar success by substituting the generically or specifically described reactants and/or operating conditions of this invention for those used in the preceding examples.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments may achieve the same results. Variations and modifications of the present invention will be obvious to those skilled in the art, and it is intended to cover in the appended claims all such modifications and equivalents. The entire disclosures of all references, applications, patents, and publications cited above are hereby incorporated by reference.

What is claimed is:

1. A radiation barrier system comprising:
a chemically reactive base layer;
a first layer at least partially disposed above said base layer;
said first layer comprising a first soil;
a second layer at least partially disposed above said first layer; and
said second layer comprising a second soil.

2. The system of claim 1 wherein said chemically active base layer is a hydro-geochemical filter barrier.

3. The system of claim 1 wherein said chemically active base layer mitigates soluble uranium or uranyl ion transport.

4. The system of claim 1 wherein said chemically active base layer filters out uranyl ions.

5. The system of claim 4 wherein uranyl ions are filtered out by a process of surface adsorption to a phase added to a lithified soil composition.

6. The system of claim 1 wherein said system is disposed over uranium-contaminated mineral.

7. The system of claim 1 wherein said first layer comprises a lithified soil.

8. The system of claim 1 wherein said second layer comprises a lithified soil.

9. The system of claim 1 wherein said first soil or said second soil comprises a basecourse aggregate.

10. The system of claim 9 wherein said basecourse aggregate comprises calcium carbonate.

11. The system of claim 1 wherein said basecourse aggregate comprises a silicate.

12. The system of claim 1 wherein said first soil or said second soil comprises a cementitious material.

13. The system of claim 1 wherein said first soil or said second soil comprises an alkaline activator.

14. The system of claim 1 wherein said first or soil said second soil comprises a clay.

15. The system of claim 1 wherein said first soil or said second soil comprises calcium magnesium alumino-silicate.

16. The system of claim 1 wherein said first layer or said second layer comprises metakaolin-lime.

17. The system of claim 1 wherein said first layer or said second layer comprises an additive.

18. The system of claim 17 wherein said additive comprises an iron oxide.

19. The system of claim 1 further comprising a monitoring system.

20. The system of claim 1 wherein said monitoring system is disposed within said radiation barrier system.
